(19) United States
(12) Patent Application Publication
(10) Pub. No.: US 2026/0178425 A1
(43) Pub. Date: Jun. 25, 2026

(54) UNIVERSAL INTERFACE SYSTEM AND ITS OPERATION METHOD

(71) Applicant: Xeroptix Infinity Limited, Hong Kong (CN)

(72) Inventors: Ka Wai KONG, Hong Kong (CN); Yajian OU, Hong Kong (CN); Shu Pang, Eddy CHAN, Hong Kong (CN)

(21) Appl. No.: 19/464,635

(22) Filed: Jan. 30, 2026

(30) Foreign Application Priority Data
Dec. 24, 2025 (HK) 32025116926.6

(51) Int. Cl. G06F 9/54; G06F 8/36

(52) U.S. Cl. CPC G06F 9/541; G06F 8/36

(57) ABSTRACT

This invention provides a universal interface system and its operation method. The universal interface system includes: an upper-layer application algorithm layer (4-1), configured to call functional modules and corresponding interfaces to complete a technical task; a fine-grained interface layer (4-2), configured to provide an abstract and unified fine-grained interface for the upper-layer application algorithm layer and define the input and output standards of each fine-grained interface; a chip adaptation layer (4-3), configured to carry out mapping between the interface specifications of the fine-grained interface and the hardware capabilities of the lower chip execution layer, and to implement the various functions defined by the fine-grained interface layer; and the chip execution layer (4-4; 4-5), configured to call chip hardware modules to perform hardware acceleration according to the technical task and return the execution results to the upper layer. This invention thus achieves the technical advantage of “one-time development, multi-chip adaptation”.

### CROSS-REFERENCE TO RELATED APPLICATION

This application claims priority to Hong Kong Short-term patent application Ser. No. 32025116926.6, entitled “UNIVERSAL INTERFACE SYSTEM AND ITS OPERATION METHOD” and filed on Dec. 24, 2025, the disclosure of which is incorporated herein by reference in its entirety for all purposes.

### TECHNICAL FIELD

The present invention relates to a universal interface system for different chip platforms. Furthermore, the present invention relates to a method for operating the universal interface system.

### BACKGROUND

Currently, leading chip manufacturers, such as NVidia, Horizon, Qualcomm, NXP, Xilinx, Rockchip (also referred to herein as RK), and Hisi, each possess their own company development kits (DevKits). The industries and specific application fields targeted by each company also vary, which has brought significant troubles to engineers and researchers engaged in hardware and/or system development. For example, difficulties arise in integrating sensors or chips of different chip manufacturers into the same application algorithm in order to resolve the compatibility between different types of sensors or chips on the one hand and upper-layer application software on the other hand. Simultaneously, this situation often makes developers and companies require long periods for integration and debugging, leading to increased project costs and inefficiency.

FIG. 1 illustrates a prior art technology, where the three blocks shown on the upper side respectively represent three aspects of customized research and development that a developer needs to perform according to actual requirements during the development process: an ALG (algorithm) or APP (application), a ROS2 (robotic operating system), and a HAL (hardware abstract layer). The lower side of FIG. 1 illustrates an example architecture of the robotic operating system platform, TogetheROS.Bot (also referred to herein as Tros), which includes various functional modules belonging to the above three aspects. This operating system platform supports running on an RDK (robotic development kit) platform. For instance, the TogetheROS.Bot platform shown in FIG. 1 can provide the following features: hobot_sensor for adapting common robotic sensors, hobot_dnn for simplifying board-end algorithm model inference and deployment, and hobot_codec for combined software and hardware acceleration of video codec, etc.

However, in the operating system platform shown in FIG. 1, the hardware abstraction layer (HAL) is fixedly configured. For an algorithm (ALG) of a specific application, the HAL is only adaptive to a fixed ROS2 operating system or a fixed chip. When the ROS2 operating system or chip changes, for example, when a bottom-layer SDK interface changes due to failure, upgrade, or other reasons, it becomes necessary to replace the intermediate component (such as the HAL); otherwise, the upper-layer algorithm (ALG) will become unavailable. Technical personnel must re-modify or debug the algorithm (ALG) for the new operating system or chip, which involves development work unrelated to the algorithm or application itself, thereby resulting in low efficiency and inconvenience of use.

### SUMMARY OF THE INVENTION

To solve the above technical problems, the present invention provides a universal interface system suitable for different chip platforms, comprising: an upper-layer application algorithm layer, configured to call functional modules and corresponding interfaces to complete technical tasks, such as data collection, computer vision (CV) processing, inference, codec, etc; a fine-grained interface layer, configured to provide an abstract and unified fine-grained interface for the upper-layer application algorithm layer, wherein the fine-grained interface layer defines input and output standards of each fine-grained interface; a chip adaptation layer, configured to implement various functions defined by the fine-grained interface layer, wherein the chip adaptation layer is responsible for mapping between interface specifications of the fine-grained interface and hardware capabilities of a lower-layer chip execution layer; and the chip execution layer, configured to call chip hardware modules to perform hardware acceleration according to the technical task and return execution results to an upper layer.

The technical concept of the present invention is based on completing core optimization of the system described in the background art and reconstructing the intermediate hardware abstraction layer (HAL). By reconstructing the HAL, hardware-related functions and acceleration capabilities are decomposed into fine-grained standardized interfaces (the fine-grained interface layer), and flexible mapping between interfaces and hardware operations is implemented by relying on a chip-specific adaptation layer. Accordingly, the present invention can ultimately achieve an isolation effect where “upper-layer algorithms control logic, while bottom-layer hardware hides implementation”. The upper-layer algorithm only needs to call unified interfaces to control functional processes without needing to concern itself with the bottom-layer chip model or sensor type. When a new chip or sensor is connected, a user only needs to develop an adapter for the interfaces, allowing for rapid reuse of all upper-layer algorithm resources. In this manner, upper-layer algorithm resources do not require any changes and can be flexibly adapted to different types of bottom-layer chips or sensors, etc.

To this end, according to the technical architecture of the present invention, the overall architecture of the HAL is divided into four layers: the upper-layer application algorithm layer, the fine-grained interface layer, the chip adaptation layer, and the chip execution layer. Among these layers, the core lies in the adaptation mechanism between the “fine-grained interface layer” and the “chip adaptation layer” (also referred to as an abstract chip layer). Each layer has clear responsibilities and functions as follows:
Upper-layer application algorithm layer: serves as the dominator of calling logic, defining “when to call interfaces or which functional interface is to be called,” and is completely independent of specific chip models and hardware implementations;
Fine-grained interface layer: provides unified functional entries covering core capabilities such as image collection, computer vision (CV) processing, model inference, and codec, and strictly defines input and output standards for each interface;
Chip adaptation layer: calls encapsulated interface libraries of different chips via an SDK or DevKit to indirectly perform mapping conversion between interface specifications and hardware capabilities;
Chip execution layer: calls a chip's own hardware modules (such as a CPU, NPU, BPU, or GPU, etc.) or sensors to complete specific tasks, acting as the direct carrier for realizing hardware acceleration capabilities. As used herein, “hardware acceleration” refers to utilizing specific hardware components to improve the overall performance and responsiveness of a system.

According to a preferred embodiment of the universal interface system, in the chip adaptation layer, each chip implements corresponding functions defined by the interface layer according to a corresponding software development kit (SDK). Each chip platform has its own dedicated media processing interface (MPI) implementation file, and a unique and unified MPI is defined by including a unified header file (or interface file) in the MPI implementation file.

Preferably, the MPI is an x_mpi interface, and the MPI implementation file is an x_mpi.cpp file, wherein the x_mpi interface is uniquely and unifiedly defined in an x_mpi.h header file of the x_mpi.cpp file, so as to be distributed across x_mpi.cpp files of different chip platforms. It should be understood by those skilled in the art that, in addition to the C language among high-level computer programming languages and programming languages derived therefrom, other similar programming languages and corresponding implementation files and header files may also be employed, which does not affect the realization of the concept of the present invention.

In the universal interface system, the chip hardware modules may include a CPU, NPU, BPU, or GPU, and/or the technical task may include data collection, data preprocessing, data inference, data encoding, data decoding, or data codec. The data may be image data, IMU (inertial measurement unit) data, or audio data. The chip hardware modules may be Rockchip chips, Hisi chips, RDK chips, NXP chips, or other types of chips or sensors.

According to an embodiment of the present invention, the universal interface system may be used to constitute a fusion system of multi-modal functional modules. In this case, the upper-layer application algorithm layer includes an algorithm service module for providing different algorithm services, and the chip execution layer includes a plurality of functional modules. The algorithm services may include data collection, data preprocessing, data inference, and/or data codec. Correspondingly, the functional modules may include a data collection module, a data preprocessing module, a data inference module, and/or a data codec module. Here, the data may be image data, IMU (inertial measurement unit) data, or audio data, and data preprocessing may include CV preprocessing.

According to another aspect of the present invention, a method for operating the universal interface system is provided, comprising: calling, by an upper-layer application algorithm layer, functional modules and corresponding interfaces to complete a technical task; providing, by a fine-grained interface layer, an abstract and unified fine-grained interface for the upper-layer application algorithm layer, wherein the fine-grained interface layer defines input and output standards of each fine-grained interface; implementing, by a chip adaptation layer, various functions defined by the fine-grained interface layer, wherein the chip adaptation layer is responsible for mapping between interface specifications of the fine-grained interface and hardware capabilities of a lower-layer chip execution layer; and calling, by the chip execution layer, chip hardware modules to perform hardware acceleration according to the technical task, and returning execution results to an upper layer.

Preferably, in the method, each chip in the chip adaptation layer implements corresponding functions defined by the interface layer according to a corresponding software development kit (SDK), wherein each chip platform has its own dedicated MPI implementation file, and a unique and unified MPI is defined by including a unified header file in the MPI implementation file. Similarly, the MPI includes an x_mpi interface, and the MPI implementation file includes an x_mpi.cpp file, wherein the x_mpi interface is uniquely and unifiedly (also referred to as abstractly) defined in an x_mpi.h header file of the x_mpi.cpp file, so as to be distributed across x_mpi.cpp files of different chip platforms.

In view of the above, the present invention has at least the following innovative features:
Standardization of fine-grained interfaces: Based on the similarity of different chip types, differentiation of various chips is weighed, and certain functions and hardware acceleration features are concluded and unified into standardized interfaces of different granularities as needed, thereby unifying input/output specifications and breaking chip binding.
Plug-in adapter design: Each chip corresponds to an exclusive adapter responsible for the mapping between interfaces and chip functional implementations, such that connecting a new chip does not require modification of upper-layer code.
Algorithm-hardware decoupling: Upper-layer algorithms and chip hardware are thoroughly separated; algorithmic iteration does not rely on hardware, and hardware replacement does not affect algorithms, thereby realizing “one-time development, multi-chip adaptation”.

Regarding the technical effects achieved by the present invention, it provides at least the following core advantages:
Adaptation efficiency: The cost of connecting a new chip is low, only requiring the development of an adapter without reconstructing the upper-layer service logic.
Performance assurance: The adapter directly interfaces with the chip manufacturer's original SDK, maximizing the utilization of hardware acceleration capabilities (such as the computing power of NPUs and GPUs).
Ecological compatibility: Supporting mainstream chips (Rockchip/Hisi/RDK, etc.) and various types of AI algorithms (YOLOv8/OCR, etc.).

### DESCRIPTION OF THE DRAWINGS

FIG. 1 illustrates a robotic operating system platform for robot manufacturers and ecological developers in the prior art.

FIG. 2 illustrates an embodiment of an operating system platform to which the universal interface system of the present invention is applied.

FIG. 3 illustrates an exemplary scenario architecture in interaction block diagram according to an embodiment of the present invention.

FIG. 4 illustrates an architectural block diagram of a codec abstract interface according to an embodiment of the present invention.

FIGS. 5A to 5B illustrate codec data flowcharts according to the embodiment of the present invention shown in FIG. 4.

FIG. 6A illustrates a first embodiment of an algorithm application architecture according to the present invention.

FIG. 6B illustrates a second embodiment of an algorithm application architecture according to the present invention.

FIG. 7A illustrates a comparison in technical effects among the prior art, the first embodiment, and the second embodiment.

FIG. 7B further illustrates a comparison in technical effects among the prior art, the first embodiment, and the second embodiment.

FIG. 8 illustrates an embodiment of an operation method of the universal interface system of the present invention.

### DETAILED DESCRIPTION

Specific embodiments of the present invention are described below based on the drawings. However, those of ordinary skill in the art will easily understand that the present invention can be implemented in many different ways, and its modes and detailed contents can be changed into various forms, and various technical features and means can be combined in different forms without departing from the technical concept and scope of the present invention. Therefore, the present invention should not be interpreted as being limited only to the content described in the present embodiments. In all drawings for explaining the embodiments, the same reference numerals are used for common parts and parts having similar functions, and repeated descriptions are omitted.

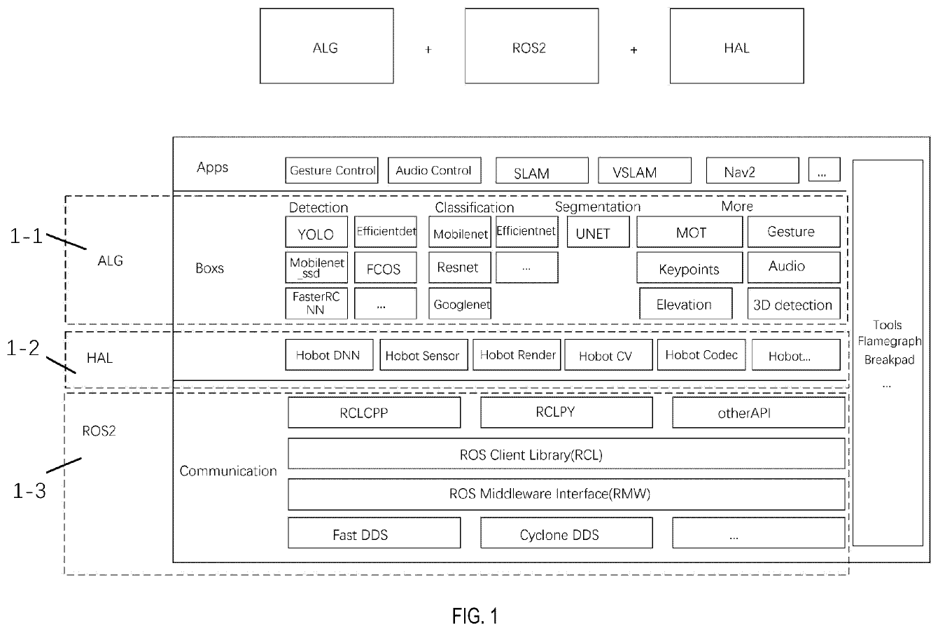

FIG. 1 illustrates a prior art robotic operating system platform (TogetheROS.Bot) for robot manufacturers and ecological developers, which has been explained in the background art of this specification.

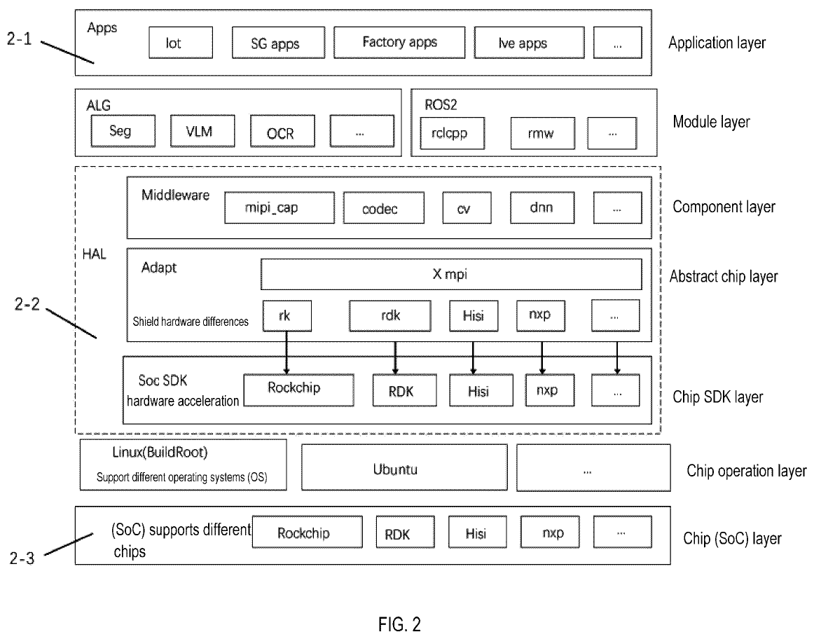

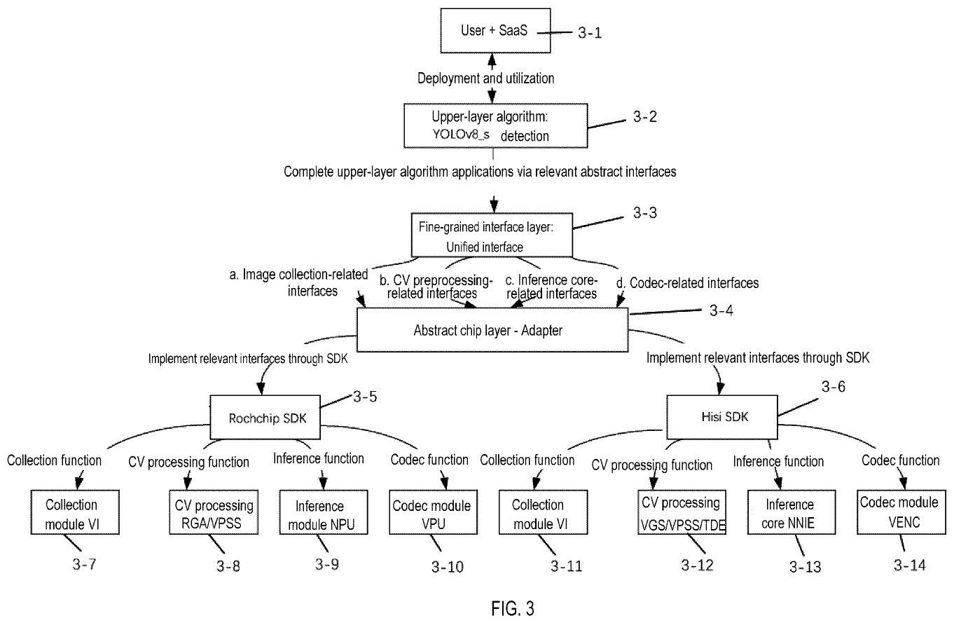

FIG. 2 illustrates an embodiment of an operating system platform to which the universal interface system of the present invention is applied. As shown in FIG. 2, the present invention reconstructs the hardware abstraction layer (HAL) 2-2, implementing it as three sub-layers, namely: a component layer, an abstract chip layer, and a chip SDK layer. Through this reconstruction, the present invention can implement the scenario architecture with interaction block diagram shown in FIG. 3.

FIG. 3 takes YOLOv8_s object detection as an example to illustrate the interaction relationship between various layers of the universal interface system of the present invention. According to the scenario core interaction logic shown in FIG. 3, a user utilizes Saas (Software as a Service) cloud technology to deploy upper-layer algorithms supported for use on different chip architectures or devices, see block 3-1. In block 3-2, the upper-layer algorithm dominates: sequentially calling each abstract and unified fine-grained interface 3-3 according to functional requirements of “image collection, CV preprocessing, inference, and codec” based on the service process, where each abstract and unified fine-grained interface 3-3 corresponds to a specific functional requirement (such as “inference with YOLOv8_s model”). The fine-grained interface layer 3-3 defines and describes each specific functional requirement based on the similarity of various chip architectures according to upper-layer service needs, and is used by the upper-layer algorithm application 3-2. For example, when using model inference, the fine-grained interface layer 3-3 will involve model assignment, model parameter setting, model inference, and post-processing of model output, etc.

In the adaptation layer 3-4, each chip implements various functions and corresponding hardware acceleration defined by the interface layer according to its respective SDK. For example, Rockchip uses an NPU for inference and an RGA for scaling, while Hisi uses an NNIE for inference and a VGS for scaling, and so on.

In the example shown in FIG. 3, SDKs from different manufacturers, here the Rockchip SDK and Hisi SDK, implement the corresponding functions defined by the illustrated interface layer 3-3, in a manner that each chip platform includes a unified header file in its own dedicated media processing interface (MPI) implementation file to define a unique and unified media processing interface.

In the chip execution layer at the very bottom of FIG. 3, hardware acceleration is executed in a manner that each chip 3-7 to 3-14 directly starts corresponding hardware to complete corresponding tasks, and results are returned to the upper layer in reverse. For the embodiment shown in FIG. 3, the key point is that the upper-layer algorithm 3-2 can complete the entire process by calling 4 major functional modules and corresponding interfaces through the fine-grained interface 3-3. Here, the 4 major functional modules are: a collection module, a CV processing module, an inference module, and a codec module. When needing to switch to Rockchip or Hisi chips, it is only necessary for the chip to implement corresponding functional modules 3-7 to 3-10 or 3-11 to 3-14, without making any modifications to the upper-layer algorithm 3-2.

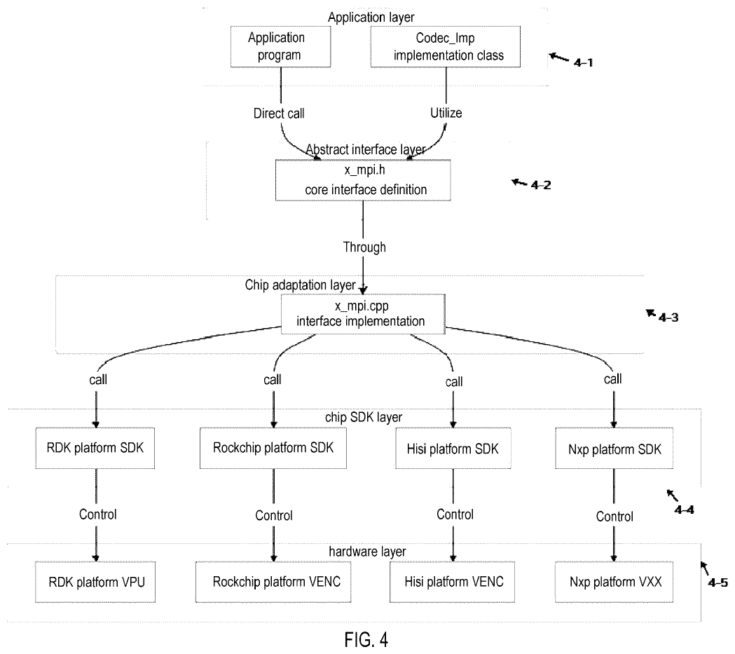

FIG. 4 clarifies a specific embodiment of reconstructing the intermediate hardware abstraction layer (HAL) according to the present invention. This embodiment relates to the design of a codec abstract interface. An application layer 4-1 implements calling of algorithms according to applications. The codec module (X_codec) in the intermediate hardware abstraction layer (HAL) of the present invention adopts a highly abstract interface design to achieve codec functions independent of hardware. This module completely separates the upper-layer application from the bottom-layer hardware implementation by defining a unified x_mpi.h interface header file, enabling application code to be seamlessly migrated across different chip platforms.

The core design principles adopted for reconstructing the codec abstract interface layer 4-2 in FIG. 4 are:
Interface standardization: defining unified x_mpi.h codec operation interfaces, including basic functions such as initialization, de-initialization, data input, and data output, to ensure uniqueness and unification (abstractness) of the interfaces;
Hardware adaptation plug-ionization: providing dedicated hardware adaptation for chip platforms such as RDK, Rockchip, Hisi, and NXP, through x_mpi.cpp implementation files of different chip platforms;
Format abstraction and unification: supporting multiple encoding formats (H264, H265, JPEG, MJPEG) and pixel formats (NV12, BGR, etc.), and managing them uniformly in the abstract layer;
Automatic resource management: automatically processing bottom-layer details such as memory allocation, buffer pool management, and resource release.

In order to implement the codec abstract interface of the present invention, it is prescribed to adopt unified data structure definitions for different types of chip platforms to form x_mpi (Media Process Interface) core interfaces for different chip platforms. Based on the x_mpi core interfaces, different types of chip platforms can then adapt to the upper-layer abstract interface layer 4-2.

Detailed explanation is as follows:

### 1. Unified Data Structure Definition

To ensure cross-platform compatibility and interface consistency, the present invention defines a series of unified data structures for describing codec-related attributes and parameters. These data structures are defined in the x_mpi.h header file to ensure consistency across all chip platforms or sensor platforms:

// Codec type enumeration
enum class XCodecType {
INVALID = 0,
// Encoding
ENCODER,
// Decoding
DECODER,
};
// Codec status enumeration
enum class CodecStatType {
STOP = 0,
START
};
// Image format enumeration
enum class CodecImgFormat {
FORMAT_INVALID = 0,
FORMAT_NV12,
FORMAT_H264,
FORMAT_H265,
FORMAT_JPEG,
FORMAT_MJPEG,
FORMAT_BGR,
};
// Frame information structure
struct FrameInfo {
uint64_t img_idx_; // Frame index
struct timespec img_ts_; // Image timestamp
struct timespec img_recved_ts_; // Receiving timestamp
struct timespec img_processed_ts_; // Processing completion timestamp
std::string frame_id_; // Frame ID
};
// Output data structure
struct OutputFrameData Type {
uint8_t *mPtrData; // Encoding output address
uint8_t *mPtrY; // Decoding Y component address
uint8_t *mPtrUV; // Decoding UV component address
int mWidth; // Width
int mHeight; // Height
int mDataLen; // Data length
CodecImgFormat mFrameFmt; // Frame format
std::shared_ptr<FrameInfo> sp_frame_info; // Frame information
};
// Codec initialization parameter base class
struct XCodecParaBase {
std::string in_format_; // Input format
std::string out_format_; // Output format
XCodec Type codec_type; // Codec type
int framerate_; // Frame rate
int mChannel_; // Channel number
float enc_qp_; // Encoding QP value
float jpg_quality_; // JPEG quality
};

These unified data structures provide a consistent data exchange format for codec operations on different platforms, enabling the upper-layer application to process data from different platforms in the same way, ensuring consistency of cross-platform implementation.

2. x_mpi (Media Process Interface) Core Interface Definition

As shown in block 4-2 of FIG. 4, the x_mpi interface is the core abstract layer of the codec module of the present invention, which is uniquely and unifiedly defined in the x_mpi.h header file, and thus implemented and distributed in x_mpi.cpp files of different chip platforms. This design ensures unification of the interface, and all platforms must follow this unique interface definition:

```
// Encoder channel attribute structure
typedef struct X_VENC_CHN_ATTR_S {
  int chn;  // Channel number
  XEncodeFormat format;  // Encoding format
  int width;  // Encoding width
  int height;  // Encoding height
  int frame_rate;  // Frame rate
  int bit_rate;  // Bit rate
  int gop_size;  // GOP size
  bool enable_hw;  // Whether to enable hardware acceleration
  float jpg_quality; // JPEG quality
} X_VENC_CHN_ATTR_S;
// x_mpi interface definition examples (defined in the unique x_mpi.h header file)
// Initialize codec
int x_mpi_venc_init(const X_VENC_CHN_ATTR_S *attr);
// De-initialize codec
int x_mpi_venc_deinit(int chn);
// Input data to encoder
int x_mpi_venc_send_frame(int chn, X_MEDIA_BUFFER_S *mb);
// Get output data from encoder
int x_mpi_venc_get_stream(int chn, X_MEDIA_BUFFER_S *mb);
// Release encoder output data
int x_mpi_venc_release_stream(int chn, X_MEDIA_BUFFER_S *mb);
// Start encoder
int x_mpi_venc_start(int chn);
// Stop encoder
int x_mpi_venc_stop(int chn);
// Set encoder parameters
int x_mpi_venc_set_param(int chn, X_VENC_RC_S *rc);
```

3. Platform Adaptation Implementation (Based on x_mpi Interface)

The x_mpi.cpp of different chip platforms is the core implementation file of the chip adaptation layer, containing specific implementations of all x_mpi interfaces. The x_mpi.cpp of each platform is adapted for a specific hardware platform and directly implements the interfaces defined in x_mpi.h:

```
// Encoder initialization implementation example in x_mpi.cpp of RDK platform
int x_mpi_venc_init(int chn, const X_VENC_CHN_ATTR_S *attr)
{
  // ... RDK platform specific encoder initialization implementation
  return 0;
}
// Encoder initialization implementation example in x_mpi.cpp of Rockchip platform
int x_mpi_venc_init(int chn, const X_VENC_CHN_ATTR_S *attr)
{
  // ... Rockchip platform specific encoder initialization implementation
  return 0;
}
```

As described above, the present invention aims to provide a novel universal platform adaptation architecture for different chip platforms 4-4 and 4-5. This adaptation architecture is specifically described as follows:

1. Adaptation Architecture with x_mpi Interface as the Core

The X_codec module takes the x_mpi interface as the core, and all interfaces are defined in the unique and unified x_mpi.h header file. This design ensures unification and standardization of the interface. Regardless of how the bottom-layer chip platform changes, the upper-layer application always operates through this set of unified interfaces. Implementations are distributed in x_mpi.cpp files of different chip platforms. Each platform's x_mpi.cpp is adapted for a specific hardware platform, ensuring consistent interface behavior.

2. Examples of x_mpi.cpp Implementations for Different Chip Platforms

Each chip platform has its own independent x_mpi.cpp implementation file, which directly implements the interfaces defined in x_mpi.h. Specific implementation details are handled by each chip platform itself:

RDK platform x_mpi.cpp implementation example:

```
// RDK platform specific x_mpi.cpp implementation
#include “x_mpi.h”
// Encoder initialization interface implementation
int x_mpi_venc_init(int chn, const X_VENC_CHN_ATTR_S *attr)
{
  // ... RDK platform specific encoder initialization implementation
  return 0;
}
// Encoder de-initialization interface implementation
int x_mpi_venc_deinit(int chn) {
  // ... RDK platform specific encoder de-initialization implementation
  return 0;
}
// Send frame data interface implementation
int x_mpi_venc_send_frame(int chn, X_MEDIA_BUFFER_S *mb) {
  // ... RDK platform specific send frame data implementation
  return 0;
}
// Get encoded stream interface implementation
int x_mpi_venc_get_stream(int chn, X_MEDIA_BUFFER_S *mb) {
  // ... RDK platform specific get encoded stream implementation
  return 0;
}
// Release encoded stream interface implementation
int x_mpi_venc_release_stream(int chn, X_MEDIA_BUFFER_S *mb) {
  // ... RDK platform specific release encoded stream implementation
  return 0;
}
Rockchip platform x_mpi.cpp implementation example:
// Rockchip platform specific x_mpi.cpp implementation
#include “x_mpi.h”
// Encoder initialization interface implementation
int x_mpi_venc_init(int chn, const X_VENC_CHN_ATTR_S *attr)
{
  // ... Rockchip platform specific encoder initialization implementation
  return 0;
}
// Encoder de-initialization interface implementation
int x_mpi_venc_deinit(int chn) {
  // ... Rockchip platform specific encoder de-initialization implementation
  return 0;
}
// Send frame data interface implementation
int x_mpi_venc_send_frame(int chn, X MEDIA BUFFER_S *mb) {
  // ... Rockchip platform specific send frame data implementation
  return 0;
}
// Get encoded stream interface implementation
int x_mpi_venc_get_stream(int chn, X_MEDIA_BUFFER_S *mb) {
  // ... Rockchip platform specific get encoded stream implementation
  return 0;
}
// Release encoded stream interface implementation
int x_mpi_venc_release_stream(int chn, X_MEDIA_BUFFER_S *mb) {
  // ... Rockchip platform specific release encoded stream implementation
  return 0;
}
Hisi platform x_mpi.cpp implementation example:
// Hisi platform specific x_mpi.cpp implementation
#include “x_mpi.h”
// Encoder initialization interface implementation
int x_mpi_venc_init(int chn, const X_VENC_CHN_ATTR_S *attr)
{
  // ... Hisi platform specific encoder initialization implementation
  return 0;
}
// Other interface implementations for Hisi platform ...
// ...
NXP platform x_mpi.cpp implementation example:
// NXP platform specific x_mpi.cpp implementation
#include “x_mpi.h”
// Encoder initialization interface implementation
int x_mpi_venc_init(int chn, const X_VENC_CHN_ATTR_S *attr)
{
  // ... NXP platform specific encoder initialization implementation
  return 0;
}
// Other interface implementations for NXP platform ...
// ...
```

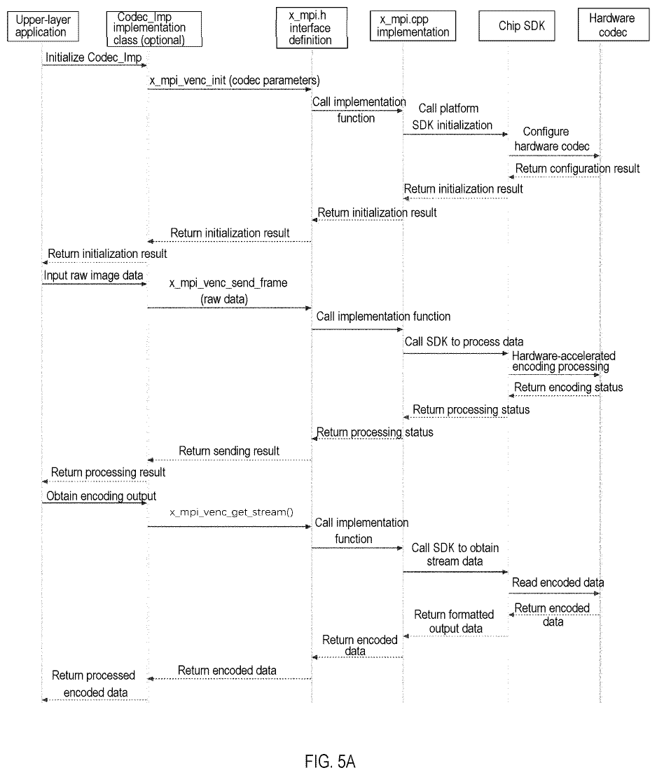

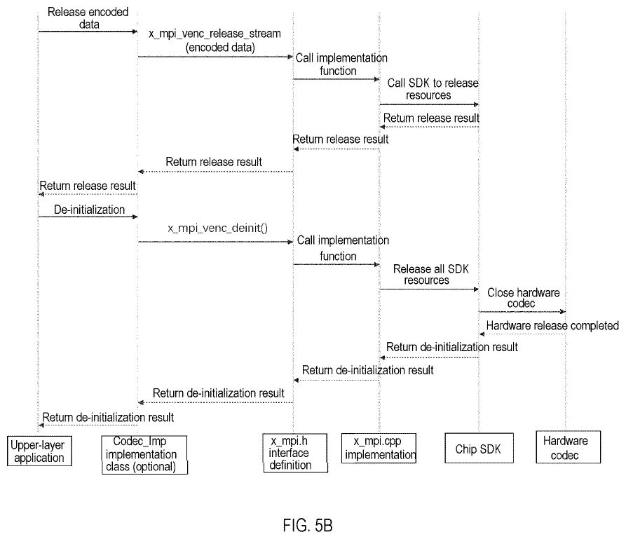

FIGS. 5A-5B show the codec data flow under the codec abstract interface architecture shown in FIG. 4 in the form of signaling diagrams in detail. As an example, the example shown in FIGS. 5A-5B relates to a codec process of image data. The application layer 4-1 (including applications and Codec_Imp implementation classes (optional)) sends an initialization command Codec_Imp and x_mpi_venc_init (codec parameters) to the chip platform (chip SDK and hardware codec) through the fine-grained interface layer (x_mpi.h interface definition) and the chip adaptation layer (x_mpi.cpp implementation). It should be understood that the chip platform here might be different types of chips, which can adapt to the fine-grained interface layer via x_mpi.h using the chip SDK.

After adaptation is completed, the bottom-layer chip platform, after completing codec configuration, returns the initialization result to the upper-layer application. Then, the upper-layer application can input image data to the bottom-layer chip and obtain returned encoded data. As shown in FIG. 5B, after completing the encoding task, the bottom-layer chip can perform de-initialization according to instructions from the upper-layer application.

Next, a specific application example is described, namely a simple codec usage based on x_mpi.

Simple Codec Usage Example Based on x_mpi

Below is shown how to directly use x_mpi interfaces for codec operations, providing a unified hardware acceleration method independent of chips for upper-layer application services:

```
// Simple encoder usage example based on x_mpi interface
int encoder_example( ) {
  // step 1. Initialize encoder configuration (using unified data structures)
  X_VENC_CHN_ATTR_S enc_config;
  memset(&enc_config, 0, sizeof(enc_config));
  enc_config.width = 1920;
  enc_config.height = 1080;
  enc_config.frame_rate = 30;
  enc_config.bit_rate = 4000000;
  enc_config.format = CODEC_TYPE_H264;
  // step 2. Directly call x_mpi interface to initialize the encoder
  void* encoder_handle = x_mpi_venc_init(&enc_config);
  if (!encoder_handle) {
    printf(“Init encoder failed\n”);
    return −1;
  }
  // step 3. Prepare input frame data (using unified data structures)
  X_MEDIA_BUFFER_S in_frame;
  memset(&in_frame, 0, sizeof(in_frame));
  in_frame.pVirAddr = yuv_data; // Assume YUV data has been allocated and filled
  in_frame.u32Width = 1920;
  in_frame.u32Height = 1080;
  in_frame.u32Format = PIXEL_FORMAT_YUV420SP_NV12;
  in_frame.u32Len = 1920 * 1080 * 3 / 2;
  // step 4. Prepare output data packet
  X_MEDIA_BUFFER_S out_packet;
  memset(&out_packet, 0, sizeof(out_packet));
  // step 5. Call x_mpi interface to send the frame for encoding
  int ret = x_mpi_venc_send_frame(encoder_handle, &in_frame);
  if (ret < 0) {
    printf(“Send frame failed\n”);
    x_mpi_venc_deinit(encoder_handle);
    return −1;
  }
  // step 6. Get the encoded data packet
  ret = x_mpi_venc_get_stream(encoder_handle, &out_packet);
  if (ret >= 0) {
    printf(“Encode success, packet size: %d\n”, out_packet.u32Len);
    // Process the encoded data packet ...
    // step 7. Release output resources
    x_mpi_venc_release_stream(encoder_handle, &out_packet);
  }
  // step 8. Release encoder resources
  x_mpi_venc_deinit(encoder_handle);
  return 0;
}
// Simple decoder usage example based on x_mpi interface
int decoder_example( ) {
  // step 1. Initialize decoder configuration (using unified data structures)
  X_VDEC_CHN_ATTR_S dec_config;
  memset(&dec_config, 0, sizeof(dec_config));
  dec_config.codec_type = CODEC_TYPE H264;
  dec_config.width = 1920;
  dec_config.height = 1080;
  // step 2. Directly call x_mpi interface to initialize the decoder
  void* decoder_handle = x_mpi_vdec_init(&dec_config);
  if (!decoder_handle) {
    printf(“Init decoder failed\n”);
    return −1;
  }
  // step 3. Prepare input bitstream data (using unified data structures)
  X_MEDIA_BUFFER_S in packet;
  memset(&in packet, 0, sizeof(in packet));
  in_packet.pVirAddr = h264_data; // Assume H264 data has been allocated and filled
  in_packet.u32Len = h264_data_len;
  in_packet.u32Flag = 0;  // 0 represents a normal frame, 1 represents a key frame
  // step 4. Prepare output frame buffer
  X_MEDIA_BUFFER_S out_frame;
  memset(&out_frame, 0, sizeof(out_frame));
  // step 5. Call x_mpi interface to send the bitstream for decoding
  int ret = x_mpi_vdec_send_stream(decoder_handle, &in_packet);
  if (ret < 0) {
    printf(“Send stream failed\n”);
    x_mpi_vdec_deinit(decoder_handle);
    return −1;
  }
  // step 6. Get the decoded frame
  ret = x_mpi_vdec_get_frame(decoder_handle, &out_frame);
  if (ret >= 0) {
    printf(“Decode success, frame size: %d\n”, out_frame.u32Len);
    // Process the decoded frame ...
    // step 7. Release output resources
    x_mpi_vdec_release_frame(decoder_handle, &out_frame);
  // step 8. Release decoder resources
  x_mpi_vdec_deinit(decoder_handle);
  return 0;
}
// Complete codec process example
int main( ) {
  // Execute encoding example
  if (encoder_example( ) < 0) {
    printf(“Encoder example failed\n”);
  }
  // Execute decoding example
  if (decoder_example( ) < 0) {
    printf(“Decoder example failed\n”);
  }
  return 0;
}
...
```

### 2. Key Point Explanation.

x_mpi interface as the core abstraction: All codecfunctions are defined through x_mpi.h interface, and the application directly calls the series of functions x_mpi_* (e.g., x_mpi_venc_init, x_mpi_venc_send_frame, x_mpi_venc_get_stream) to realize the functions.
Chip-independent usage: The upper-layer application code remains completely consistent and does not need to concern itself with whether the bottom layer consists of different chip platforms such as RDK, Rockchip, Hisi, or NXP.
Unified data structures: Unified data structures defined in x_mpi.h (such as X_VENC_CHN_ATTR_S and X_MEDIA_BUFFER_S) are utilized for parameter configuration and data transmission.
Complete resource management: The examples demonstrate the correct processes for resource initialization and release, ensuring that no memory leaks occur.

### 3. Multi-platform Unified Application Development

Through the x_mpi interface, the same application code can run across different chip platforms:

```
// This code can run on RDK, Rockchip, Hisi, and NXP platforms
void video_processing_app( ) {
  // Initialize codec (using unified interfaces)
  void* encoder = x_mpi_venc_init(&enc_config);
  void* decoder = x_mpi_vdec_init(&dec_config);
  // Perform codec operations (using unified interfaces)
  // ...
  // Release resources (using unified interfaces)
  x_mpi_venc_deinit(encoder);
  x_mpi_vdec_deinit(decoder);
}
```

Accordingly, this design enables the application layer code to focus on service logic without needing to address the differences between bottom-layer platforms, while simultaneously achieving efficient codec performance through the MPI interface.

Through the above descriptions, the following technical innovations and advantages of the embodiments of the present invention can be obtained:

### 1. Key Innovation Points

x_mpi core abstract design: All codec functions are defined through the x_mpi.h interface and implemented by the x_mpi.cpp of each platform, ensuring the uniqueness and unification of the interface.
Hardware adaptation plug-ionization: Dedicated adaptation to platforms such as RDK, Rockchip, Hisi, and NXP is achieved through the implementation of x_mpi.cpp on different chip platforms.
Flexible format support: Multiple encoding and pixel formats are abstractly supported, facilitating flexible configuration by upper-layer applications.
Efficient resource management: Resources such as memory allocation and buffer pool usage during the codec processes are automatically managed to avoid memory leaks.

### 2. Core Advantages

Cross-platform compatibility: The same set of application code can run on different platforms such as RDK, Rockchip, Hisi, and NXP.
Development efficiency improvement: Developers only need to learn the unified x_mpi.h interface and do not need to learn the SDK interfaces of different platforms.
Maintenance cost reduction: Interface changes only require modification of the x_mpi.h header file definition, and each platform updates its corresponding x_mpi.cpp implementation.
Performance optimization potential: The x_mpi.cpp of each platform directly calls the chip manufacturer's original SDK, maximizing the utilization of hardware acceleration capabilities.

In addition, the present invention provides various practical application scenarios. For example, the abstract interface design of the X_codec module has significant advantages in the following scenarios:
1. Multi-platform video surveillance systems: The same set of surveillance software can be deployed on devices across different chip platforms such as RDK, Rockchip, Hisi, and NXP.
2. AI edge computing devices: Seamless migration of algorithms and applications is achieved among edge devices with different computing powers.
3. Video conference terminals: Support for consistent video codec functions on different hardware platforms is provided.
4. In-vehicle multimedia systems: Adaptation to hardware platforms of different vehicle models is achieved, providing unified video processing capabilities.

Through this standardized abstract interface design, the universal interface system of the present invention successfully achieves the goal of “one-time development, multi-platform operation”, significantly reducing the costs of cross-platform development and maintenance.

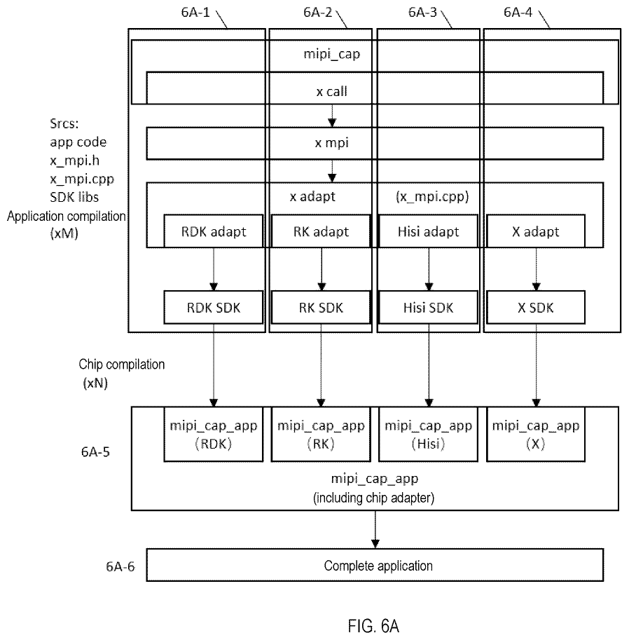

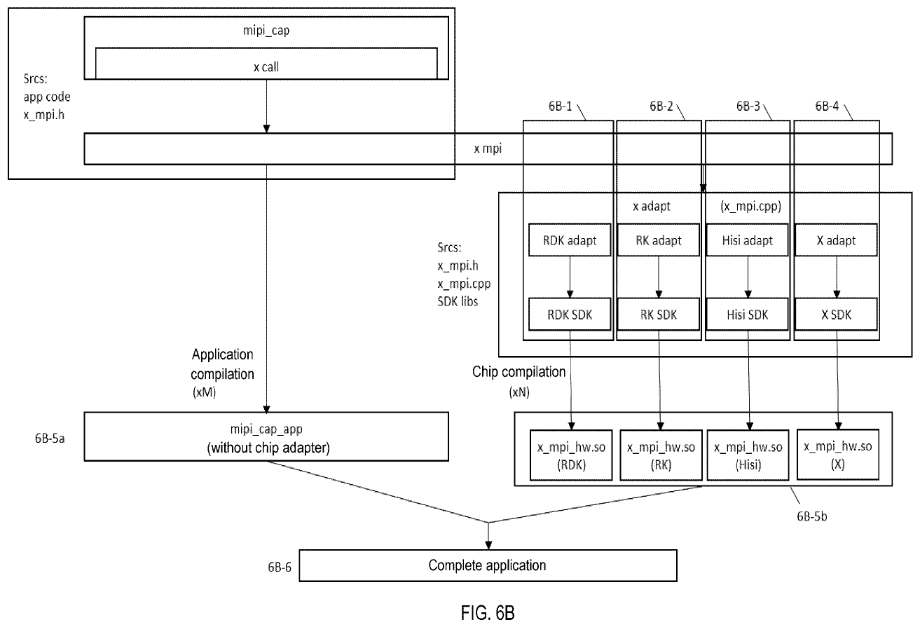

The effect of improving development efficiency is further illustrated below through an application example of data collection, mipi_cap. It should be understood that mipi_cap is merely an example of an image data collection application, and those skilled in the art can also implement any other applications or algorithms within the architecture of the present invention. FIG. 6A and FIG. 6B respectively illustrate the first and second embodiments of the algorithm application architecture according to the present invention. The first embodiment shown in FIG. 6A may correspond to, for example, the architecture shown in FIG. 3 or FIG. 4, wherein the x_mpi layer corresponds to the abstract interface layer 4-2, and the x_adapt layer corresponds to the chip adaptation layer 4-3. The final products of the first and second embodiments are complete applications (6A-6, 6B-6) capable of supporting the corresponding chips. In FIG. 6A, reference numerals 6A-1, 6A-2, 6A-3, and 6A-4 respectively represent compilation objects, while reference numeral 6A-5 represents the result of the compilation. The second embodiment shown in FIG. 6B is further improved based on the architecture of the first embodiment shown in FIG. 6A, wherein reference numerals 6B-1, 6B-2, 6B-3, and 6B-4 respectively represent compilation objects. This reconstructed second embodiment is primarily optimized for code organization and the compilation-execution mechanism, achieving the goal of “pre-compilation and subsequent utilization,” thereby improving development and deployment efficiency, and is applicable to various algorithms and applications in the system.

The first and second embodiments shown in FIG. 6A and FIG. 6B are described in detail below, and a detailed comparison is made between them.

Both the first and second embodiments can achieve, for a developer or a user, support for M algorithms or applications based on N chips or devices. In the architecture of the first embodiment shown in FIG. 6A, support for algorithms or applications on multiple chips or devices is realized by configuring an x_mpi interface, and support for the M algorithms or applications by the chip or device is realized by configuring N chip adapters, without the need to modify the algorithms or applications to adapt to different chips.

The architecture shown in FIG. 6B is similar to FIG. 6A, also implementing algorithms or applications through x_mpi. The difference between them lies in that, in the manner shown in FIG. 6A, each application must specify a chip (i.e., a chip adapter needs to be compiled) when compiling to generate a software package of a final executable program (6A-6), which means that in the software package of the final executable program, the chip adapter and the software package are inseparable from each other. It should be noted that the advantage of the manner shown in FIG. 6A relative to the prior art is that a developer does not need to modify the algorithm and application layers to adapt to different chips; however, when compiling the adapter, the developer still needs to perform compilation separately according to different chips. In the manner shown in FIG. 6B, it is no longer necessary to perform compilation as in FIG. 6A, because through the manner shown in FIG. 6B, a developer only needs to compile the application layer (i.e., mipi_cap_app (without a chip adapter) 6B-5a). In the manner shown in FIG. 6B, the connection between the application layer and the intermediate abstract layer is established through link libraries. Specifically, when an application algorithm is compiled, only programs or executable files related to the content of the generated application algorithm in the aforementioned application layer are compiled, which does not include chip-related content, while the chip adaptation layer (chip-related content) is compiled into a shared library (so; shared objects; application-independent link library) of the adaptation layer, which corresponds to the x_mpi_hw.so (chip adapter) 6B-5b in FIG. 6B. Thus, a complete application algorithm 6B-6 can use two parts at runtime, which include the aforementioned mipi_cap_app (without a chip adapter) 6B-5a and x_mpi_hw.so (chip adapter) 6B-5b, wherein the two parts are separate and are also connected through a unified SDK interface abstraction (i.e., x_mpi), such that the application layer and the chip adaptation layer follow a unified abstract interface specification.

In the manner shown in FIG. 6A, as indicated by the horizontally arranged blocks, 6A-1, 6A-2, 6A-3, and 6A-4 are sequentially the architecture parts for implementing algorithm applications on RDK, RK, Hisi, and X (i.e., any) chips, wherein code of the chip adaptation layer is compiled into the algorithmic applications. Thus, due to application correlation and chip correlation, for the requirement of adapting to N different chips, each application is compiled N times, and hence M applications need to be compiled N×M times. In comparison, in the manner shown in FIG. 6B, the application algorithm and the chip adaptation layer code are compiled separately and independently. As shown in blocks 6B-1, 6B-2, 6B-3, and 6B-4, each application is only compiled once, and each chip is only compiled once, thus for M applications, a total of M+N compilations are required. In case of a plenty of applications, the latter requires obviously less compilation times and hence is more efficient.

The first and second embodiment architectures shown in FIG. 6A and FIG. 6B have the following differences in management and maintenance:
In the first embodiment of FIG. 6A: the code of the application algorithm application and the code of the chip adaptation layer are managed together. Modifying of the algorithm and application layers and the chip adaptation layer each is based on the same code base; i.e., although the two are not coupled during development, the code management and compilation of the two are in the same base (namely same code base).
In the second embodiment of FIG. 6B: the algorithmic application code and the chip adaptation layer code are managed separately. Personnel in charge of algorithm application only need to compile the algorithmic application code base and do not see the chip adaptation layer. Conversely, the same is true for the chip adaptation layer. Ultimately, each component can be maintained separately without mutual interference, facilitating future maintenance and updates.

The architecture of the first embodiment of FIG. 6A has already realized the separation of chip code and applications, and its main features include:
Independent chip adaptation layer: each chip has independent adaptation layer code, interacting with the application layer through a unified interface;
Binding of application and chip compilation: each application program needs to be separately compiled once for each chip platform;
Expansion method: when a new chip is supported, it is only necessary to adapt the new chip, without modifying the application program code, but the application needs to be recompiled;
Number of compilations: if there are M applications and N chips, a total of M×N compilations are required.

On the basis of FIG. 6A, the preferred architecture of the second embodiment of FIG. 6B optimizes the code organization and the compilation-execution mechanism, and its main features include:
Independent chip adaptation layer: the separation of chip code from applications is maintained, and each chip has independent adaptation layer code;
Decoupling of application compilation from chips: each application program only needs to be compiled once for the platform to generate a universal executable file;
dynamic linking at runtime: when a program runs, it automatically loads a corresponding implementation library according to the current chip;
Expansion method: when a new chip is supported, it is only necessary to adapt the new chip and compile the implementation library of the corresponding chip, without the need to recompile the application;
Number of compilations: applications are compiled M times, and the chip adaptation layer is compiled N times, for a total of M+N compilations.

The differences in architecture between the first and second embodiments can be understood through an easy-to-understand analogy of “large equipment and displays”:

TABLE 1

| Component | Analogy Object |
|---|---|
| Application program/Algorithm | Large equipment (such as a host, |
| | game console, etc.) |
| Chip implementation | Display |
| Final product | A complete device with display |
| | function |
| Unified interface | HDMI interface standard |
| Dynamic linking at runtime | HDMI cable |

Accordingly, the first embodiment can be analogized as:
The large equipment and the display are “packaged as a whole”;
Every time a display or equipment is changed, it needs to be “re-packaged as a new product”;
Number of final products=types of equipment×types of displays.

Correspondingly, the second embodiment can be analogized as:
The large equipment and the display are “produced independently,” connected by “HDMI cable (dynamic linking)” in between;
Equipment and displays both only need to be produced once, “without needing to be packaged as a whole”;
When there is a product requirement, “use HDMI cable” to connect the corresponding equipment and displays;
Number of final combinable products=types of equipment×types of displays, but number of actually produced components=types of equipment+types of displays.

Next, the implementation logic of the second embodiment architecture is explained. The core design principle of the second embodiment architecture is the “pre-compilation and subsequent utilization” principle, namely:
At compilation time: When an application program is compiled, it does not need to specify a target chip and only needs to link to the unified interface;
At runtime: The system automatically matches a corresponding implementation library

In the second embodiment architecture, the application layer contains various types of applications with algorithms as the core (such as mipi_cap data collection application), and an independent executable program (such as mipi_cap_app) generated by compilation realizes its functions by calling standardized APIs (such as initialization, starting, data processing, etc.) provided by the unified interface layer (x_mpi), without needing to perceive bottom-layer hardware differences. Below the unified interface layer is the chip adaptation layer (x_adapt), which respectively implements the above-mentioned standard interfaces for different chips (such as RDK, RK, Hisi, or X), internally completes actual hardware operations by calling specific functions of each chip's SDK to complete actual hardware operations, and is compiled into a unified dynamic link library (such as chip-independent x_mpi_hw.so) for loading by the upper layer. This architecture ensures universality of application layer code and programs. Only by replacing or adapting chip-related dynamic libraries can the system be deployed on different hardware platforms.

The work process of an embodiment of the present invention usually includes the following stages:
Application development: When a developer writes an application, functions of the unified interface layer are called;
Application compilation: When the application program is compiled, it only links to the unified interface layer to generate a universal executable file;
Chip adaptation layer compilation: For each chip, the unified interface layer and the SDK of the chip are compiled into a dedicated implementation library (x_mpi_hw.so);
Dynamic linking at runtime: When the application program runs, the system automatically loads a corresponding x_mpi_hw.so to realize calling of functions.

In aspects of compilation and running, the first and second embodiments have the following differences:

TABLE 2

| | First embodiment | Second embodiment |
|---|---|---|
| Phase | architecture | architecture |
| Application | Call unified interface | Call unified interface |
| development | | |
| Application | Compile application | Only compile universal |
| compilation | once for each chip | application once |
| Chip | Each chip implements | Each chip implements unified |
| adaptation | unified interface | interface |
| Deployment | Provide independent | Provide universal executable |
| method | executable files | file + implementation |
| | for each chip | libraries foreach chip |
| Running | Executable file directly | Runtime dynamic loading of |
| mechanism | contains chip | implementation library of |
| | implementation | corresponding chip |

Taking a practical work process as an example, assume we have two application programs (image collection application, image encoding application) and two chip platforms (X3, RV1126B):

Under the architecture of the first embodiment:
The image collection application needs to be compiled twice (X3 version and RV1126B version);
The image encoding application needs to be compiled twice (X3 version and RV1126B version);
A total of 4 compilations are needed;
If a chip platform is newly added, applications need to be compiled 2 more times;

Under the architecture of the second embodiment:
The image collection application only needs to be compiled once (universal version);
The image encoding application only needs to be compiled once (universal version);
The adaptation layer is compiled once for each chip platform (generating x_mpi_hw.so);
A total of 1+1+2=4 compilations are needed (same total number in this scenario);
If a chip platform is newly added, it is only necessary to compile the adaptation layer 1 more time without needing to modify or recompile applications.

In contrast, the second embodiment has long-term advantages. When the number of applications and chip platforms increases, the advantage of the second embodiment will be more obvious:

TABLE 3

| | | Number of | Number of |
|---|---|---|---|
| Number of | Number of | compilations of | compilations of |
| applications | chips | first embodiment | second embodiment |
| 2 | 2 | 4 | 4 |
| 5 | 3 | 15 | 8 |
| 10 | 5 | 50 | 15 |
| 20 | 10 | 200 | 30 |

Accordingly, the second embodiment architecture can achieve the following core advantages:

### 1. Improvement of Compilation Efficiency:

Application programs only need to be compiled once, reducing repeated compilation work;
When a chip platform is newly added, all applications do not need to be recompiled;
Compilation time and resource consumption are significantly reduced.

### 2. Enhancement of Deployment Flexibility:

Application programs can run directly on different chip platforms without needing to recompile;
Chip implementation libraries can be dynamically switched as needed;
It facilitates cross-platform testing and verification.

### 3. Reduction of Maintenance Cost:

Application programs and chip adaptation layers are maintained independently, reducing mutual influence;
Modification of the chip adaptation layer will not affect application programs;
Unified interface design facilitates code management and maintenance.

### 4. Enhancement of Expandability:

Support “pre-compilation and subsequent utilization,” and applications can run on any supported chip after compilation;
Newly added chip platforms only need to add corresponding adaptation layers;
Facilitate third-party developers to develop adaptation layers for new chips.

In general, compared with the first embodiment, the core difference of the reconstructed second embodiment according to the present invention lies in code organization and compilation running mechanisms rather than interface usage and code implementation. After reconstruction, the architecture maintains separation of chip code and applications and, at the same time, optimizes compilation and deployment processes through the design concept of “pre-compilation and subsequent utilization,” improving development efficiency and deployment flexibility, and is applicable to various algorithms and applications in the system.

Taking an image collection application as an example, after reconstruction, an application program only needs to be compiled once to run on all supported chip platforms, and at runtime, it can automatically match a corresponding chip implementation library. This design not only improves compilation efficiency but also strengthens expandability and maintainability of the system, laying a foundation for supporting more chip platforms in the future.

Through the analogy of “large equipment” and “display” introduced above, the advantages of this architecture can be understood more intuitively: just as the HDMI interface standard unifies connection manners of equipment and displays, the reconstructed architecture also realizes efficient decoupling and flexible combination of application programs and chip platforms through a unified interface and dynamic linking mechanism.

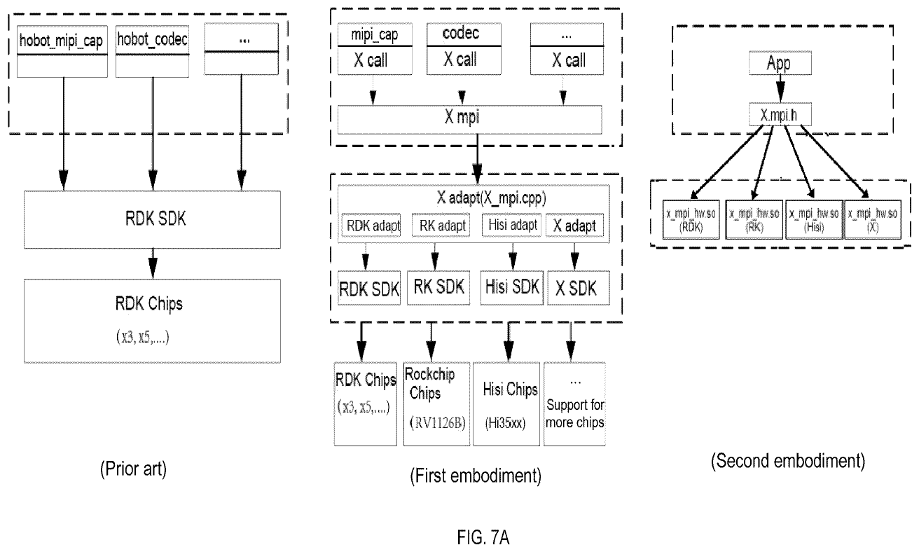

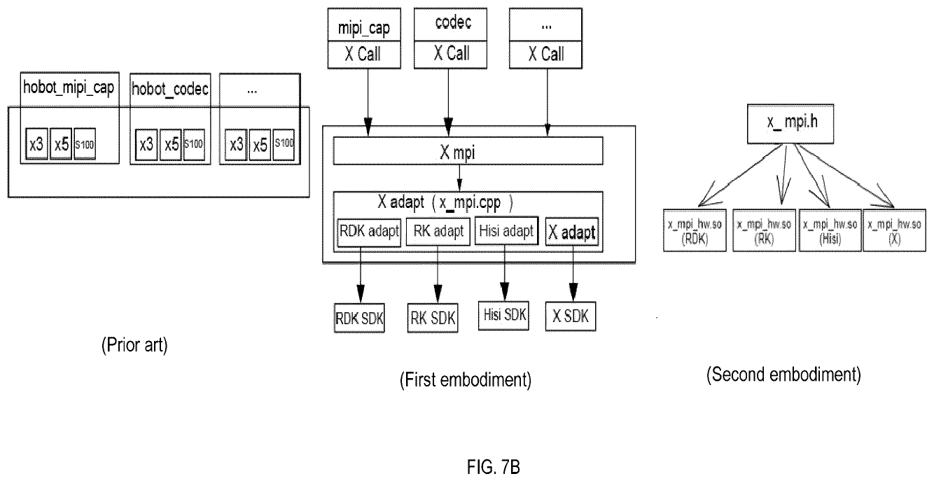

FIG. 7A and FIG. 7B illustrate comparisons in technical effects among the prior art, the first embodiment, and the second embodiment, respectively. FIG. 7A and FIG. 7B provide the evolution from the prior art to the present invention (the first embodiment) and then to the preferred mode of the present invention (the second embodiment) from left to right, respectively.

The left side of FIG. 7A illustrates the prior art (e.g., Tros of Horizon Company), which achieves the objective of supporting multiple chips within the RDK by implementing application-level abstraction. This prior art has the following characteristics: it has application-level HAL abstraction; the various chips of the RDK implement the aforementioned application-level abstraction; it can only connect to chips that support the RDK and cannot connect to chips that support other types; and the algorithm application needs to be coupled with chip characteristics.

The middle of FIG. 7A illustrates the first embodiment of the present invention, which achieves the objective of realizing multi-chip support. This embodiment has the following characteristics: having chip SDK-level abstraction; having more extensive abstraction to support more chip types; realizing isolation between algorithm applications and chip characteristics; and no code modification required, although recompilation is still necessary.

The right side of FIG. 7A illustrates the preferred second embodiment of the present invention, which achieves the objective of completely eliminating the dependency of the algorithm installation package (the compilation product of the algorithm) on the chip. This preferred embodiment has the following characteristics: when the algorithm is compiled with the application, it is not necessary to know which chips need to be supported in the future; and when a new chip is added, it is not necessary to recompile the original algorithm and application. That is, the advantage of “pre-compilation and subsequent utilization” can be achieved. This mode is similar to the concept of “dll” (Dynamic Link Library), which can be implemented on different chips by replacing the bottom-layer “dll”.

FIG. 7B also illustrates comparisons in technical effects among the prior art, the first embodiment, and the second embodiment, respectively, and provides supplementary explanations for the content of FIG. 7A.

In the prior art (e.g., Tros of Horizon Company) shown on the left side of FIG. 7B, application-level HAL abstraction must be performed according to the needs of each algorithm and application. For each algorithm or application, there are corresponding implementations of the aforementioned abstraction by different chips (e.g., RDK chips).

Therefore, for M applications and N chips, this results in M×N HAL adaptations, where every time a chip is added, M adaptations are added to realize the aforementioned application-level HAL abstraction.

According to the first embodiment of the present invention shown in the middle of FIG. 7B, the HAL abstraction is decoupled from the applications by performing unified HAL abstraction at the SDK chip level rather than at the application level. For each algorithm or application, adaptation development is performed using chip-independent unified SDK-level abstraction. Thus, for M applications, only M HAL adaptations are required, where every time a chip is added, support for algorithm applications can be realized by adding only one adaptation (the corresponding chip implementation of the SDK-level abstraction). That is, for N chips, M+N HAL adaptations are performed. Regarding compilation, the compilation of the specific chip HAL abstraction is extended into the applications; thus, for M applications, M×N compilations are required, where every time a chip is added, M compilations are added.

According to the preferred second embodiment of the present invention shown on the right side of FIG. 7A, the implementation of the chip HAL abstraction exists in the form of, for example, a “so” (shared library); thus, for M applications, only M+N compilations are required, where every time a chip is added, only one compilation is added.

In general, the evolution from the prior art to the first embodiment of the present invention solves the problem where the adaptation of different chips requires re-development from the algorithm and application layers, which is the process of the intermediate layer from the left side of FIG. 7A to the center of FIG. 7A. Meanwhile, compared with the prior art, the first embodiment shown in the center of FIG. 7A optimizes the level of abstraction, improving it from application-level abstraction to chip-level abstraction, enabling it to be adapted to and used for all applications through the implementation of the abstraction by different chip manufacturers, while providing a basis for the evolution from the first embodiment to the second embodiment.

The evolution from the first embodiment shown in the center of FIG. 7A to the second embodiment shown on the right side of FIG. 7A solves the problem where applications for different chips need to be recompiled. The second embodiment unifies the chip adaptation layers of all applications into one “so” (shared library); thus, every time a new chip is added, only one compilation is required, while each application only needs to be compiled once and no longer needs to be compiled for adapting to different chips.

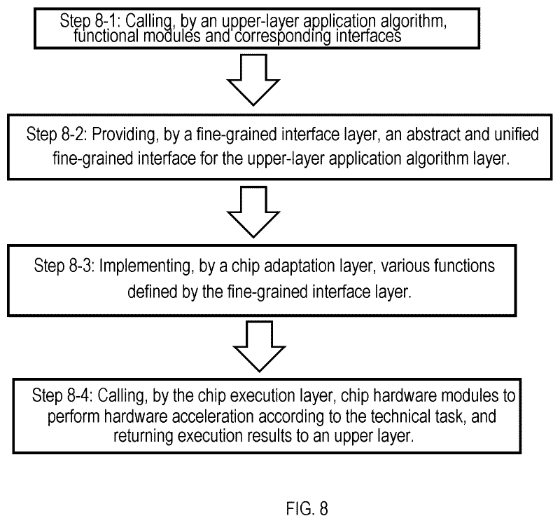

FIG. 8 illustrates an embodiment of an operation method of the universal interface system of the present invention.

According to the method flowchart shown in FIG. 8, in step 8-1, functional modules and corresponding interfaces are called through an upper-layer application algorithm to complete a technical task. The technical task is, for example, image collection, image data preprocessing, image inference, or codec, etc. In step 8-2, an abstract and unified fine-grained interface is provided for the upper-layer application algorithm layer through a fine-grained interface layer, wherein the fine-grained interface layer defines input and output standards of each fine-grained interface. In step 8-3, various functions defined by the fine-grained interface layer are implemented through a chip adaptation layer, wherein the chip adaptation layer is responsible for mapping between interface specifications of the fine-grained interface and hardware capabilities of a lower-layer chip execution layer. Finally, in step 8-4, hardware acceleration is executed through the chip execution layer by calling chip hardware modules according to the technical task, and execution results are returned to the upper layer.

As used herein, terms such as “having,” “containing,” “comprising,” “including,” and the like are open-ended terms, which indicate the presence of stated elements or features but do not exclude additional elements or features. Considering the above range of variations and applications, it should be understood that the present invention is not limited by the description of the foregoing embodiments nor by the drawings. Instead, the present invention is limited only by the appended claims and their legal equivalents, and relevant technical features in the claims can be freely combined according to specific implementation scenarios.

What is claimed is:

1. A universal interface system for different chip platforms, comprising:
an upper-layer application algorithm layer (4-1), configured to call functional modules and corresponding interfaces to complete a technical task;
a fine-grained interface layer (4-2), configured to provide an abstract and unified fine-grained interface for the upper-layer application algorithm layer (4-1), wherein the fine-grained interface layer defines input and output standards of each fine-grained interface;
a chip adaptation layer (4-3), configured to implement various functions defined by the fine-grained interface layer (4-2), wherein the chip adaptation layer (4-3) is responsible for mapping between interface specifications of the fine-grained interface and hardware capabilities of a lower-layer chip execution layer; and
the chip execution layer (4-4; 4-5), configured to call chip hardware modules to perform hardware acceleration according to the technical task and return execution results to an upper layer.

2. The universal interface system according to claim 1, characterized in that in the chip adaptation layer (4-3), each chip implements corresponding functions defined by the interface layer according to a corresponding software development kit (SDK),
wherein each chip platform has its own dedicated media processing interface (MPI) implementation file, and a unique and unified media processing interface is defined by including a unified header file in the media processing interface (MPI) implementation file.

3. The universal interface system according to claim 2, characterized in that the media processing interface (MPI) is an x_mpi interface, the media processing interface (MPI) implementation file is an x_mpi.cpp file, wherein the x_mpi interface is uniquely and unifiedly defined in an x_mpi.h header file of the x_mpi.cpp file, so as to be distributed in x_mpi.cpp files of different chip platforms.

4. The universal interface system according to claim 2, characterized in that the chip hardware modules include a CPU, an NPU, a BPU, or a GPU, and/or the technical task includes data collection, data preprocessing, data inference, data encoding, data decoding, and/or data codec.

5. The universal interface system according to claim 2, characterized in that the chip hardware modules include a Rockchip chip, a Hisi chip, an RDK chip, or an NXP chip.

6. The universal interface system according to claim 1, characterized in that the universal interface system forms a fusion system of multi-modal functional modules,
wherein the upper-layer application algorithm layer includes an algorithm service module for providing different algorithm services, and the chip execution layer includes a plurality of functional modules.

7. The universal interface system according to claim 6, characterized in that the algorithm services include data collection, data preprocessing, data inference, and/or data codec, and the functional modules include a data collection module, a data preprocessing module, a data inference module, and/or a data codec module.

8. A method for operating the universal interface system according to claim 1, comprising:
calling, by an upper-layer application algorithm layer (4-1), functional modules and corresponding interfaces to complete a technical task;
providing, by a fine-grained interface layer (4-2), an abstract and unified fine-grained interface for the upper-layer application algorithm layer, wherein the fine-grained interface layer defines input and output standards of each fine-grained interface;
implementing, by a chip adaptation layer (4-3), various functions defined by the fine-grained interface layer, wherein the chip adaptation layer is responsible for mapping between interface specifications of the fine-grained interface and hardware capabilities of a lower-layer chip execution layer; and
calling, by the chip execution layer (4-4; 4-5), chip hardware modules to perform hardware acceleration according to the technical task, and returning execution results to an upper layer.

9. The method according to claim 8, characterized in that in the chip adaptation layer (4-3), each chip implements corresponding functions defined by the interface layer according to a corresponding software development kit (SDK),
wherein each chip platform has its own dedicated media processing interface (MPI) implementation file, and a unique and unified media processing interface is defined by including a unified header file in the media processing interface (MPI) implementation file.

10. The method according to claim 9, characterized in that the media processing interface (MPI) is an x_mpi interface, the media processing interface (MPI) implementation file is an x_mpi.cpp file, and the x_mpi interface is uniquely and unifiedly defined in an x_mpi.h header file of the x_mpi.cpp file, so as to be distributed in x_mpi.cpp files of different chip platforms.
